(19) United States
(12) Patent Application Publication
(10) Pub. No.: US 2002/0019842 A1
(43) Pub. Date: Feb. 14, 2002

(54) Automated subscriber document directory system

(76) Inventor: George R. Law, Pfafftown, NC (US)

Correspondence Address: George R. Law, 3655 Transon Rd., Pfafftown, NC, 27040, US

(21) Appl. No.: 09/876,327

(22) Filed: Jun. 7, 2001

Related U.S. Application Data
(60) Provisional application No. 60/210,483, filed on Jun. 9, 2000.

(51) Int. Cl. G06F 17/00

(52) U.S. Cl. 709/1; 713/193

(57) ABSTRACT

An automated file and directory system listing various types of information with links directly to specific electronic documents. This unique flat file directory listing procedure is electronically automated and synchronized to facilitate storage, search, and retrieval of documents. A Subscriber can list an electronic document in the directory. This automated listing process requires the input of specific data relevant to that specific document. This data is then used to create a unique flat file name consisting of fields and/or flags with value, thereby providing the pertinent technical intelligence required for the system to operate. Each value provides a reference that integrates with the ASDDS Search Engine Module. The search and retrieval methodology involved would include an interactive request form, which the User would use to define a listing. Such definition may be as specific, or as broad as the searcher wishes. Upon receiving these criteria, the system will perform a file and directory search process, interrogating the unique flat file naming configuration. The system will find the desired information and supply the User with a listing of relevant electronic documents and information and their corresponding links. The User is then able to view and traverse this listing in order to find the desired specific information. If necessary the User may further refine the search criteria. Once the desired information has been found, the User would have the ability to link to the associated electronic documents.

### BACKGROUND OF THE INVENTION

1. Field of the Invention

The present invention relates to the management of information through directories that employ cryptic file names to store, search for and retrieve documents and information.

2. Description of Related Art

Most directories are simply a compilation of files contained in a storage device. Usually these directories have listings in alphabetical order or classified by names, addresses, numbers and other data. Some directories have listings sorted by the various characteristics of the file, such as the layout of its data, or its type of use. Most directories are fast and easy to use.

Directory systems are of great value only if they are kept current and organized. As the amount of information increases in size and more individuals access and store data on these systems, the directory's organization and maintenance will become more chaotic. This usually requires an individual or company division to constantly devote resources for its upkeep. Also if storage and maintenance practices are not standardized, specific information and files can be misplaced and retrieval may be hindered or impossible.

A good directory system will still have limitations. Even in well-organized and maintained directories information and files will get lost. For example, you may look for a file that corresponds to “animals,” “dogs,” and “canine” and still not find a file because someone else has filed it under “pets,” or worse under “my pets.”The larger the system the greater the problem. Furthermore, directories are not normally used for specific content management. If the contents of a file does not “fit” any current categories, the file must still be placed somewhere (so it is virtually lost,) or else it is actually deleted.

At present a directory can only present a listing (usually a file name) which is intended for file identification. The name of a file might not be logical and often will have little relevance to that file's content. If that file was misidentified, time and resources will be lost trying to search and retrieve it. But, even when the desired file is located, the name of a file does not catalogue its content, the age of its information, its author and ownership, its topic, or its relationship to other documents.

Currently, databases are used for storage and retrieval of large amounts of information. When specific information needs to be accessed or updated, a database with information on the topic may address the specific information by indexing its configuration to find the location and access that specific information. Large relational databases with tables containing records and fields of data are often used to find and retrieve data. Updating this information might even require the accessing of multiple databases and the correlation of all data spread between them. Of course, all this correlation requires even more time to access and maintain. There's also the problem of the lag time between updating the information from a network database and its relational database. Besides, these databases generally require diverse equipment, disparate systems, and other resources for their own management.

The simplicity and speed of a directory compilation needs to be combined with the content search and management capabilities of a database.

### SUMMARY

The present invention provides a system for storing, searching, and retrieving a directory listing of subscribed electronic documents and other relevant information. The critical aspect of this directory listing system is a cryptic file-naming configuration. The preferred embodiment includes an automated application for System File Entry Processing where a Subscriber lists documents by entering information into an electronic request document which then creates a cryptic file name, a flat file and a link to the listed document. The cryptic file name is configured with characters with defined values as placeholders for defined fields and flags (and the flat file itself may contain more information about the listing.) The System also includes an automated search application where a User may define search criteria and the Search Engine Module then interprets variables that correspond to flat file naming configuration, interrogates for matched fields and/or flags, and finally compiles and returns to the User a listing of files.

### BRIEF DECRIPTION OF THE DRAWINGS

FIG. 1 shows the complete Automated Subscriber Document Directory System (ASDDS) Process.

FIG. 2 depicts how to access the ASDDS.

FIG. 3 shows the automated process for ASDDS Flat File Entry and Configuration.

FIG. 4 shows the presentation of the Information Request Document to Subscriber.

FIG. 5 depicts the submission of Subscriber's Information Request Document.

FIG. 6 shows the ASDDS Subscriber File Entry Processing Module.

FIG. 7 is a sample of the ASDDS-FFC and Unique File Naming Convention.

FIG. 8 depicts the presentation of the Search Request Document to User.

FIG. 9 depicts the submission of User's Search Request Document.

FIG. 10 shows the ASDDS Search Engine Module.

FIG. 11 shows the ASDDS Directory Listing of Subscriber Documents and Associated Links.

FIG. 12 shows the completion of the process resulting in a link to the Document of Interest or the ability to begin a New Search.

### DETAILED DESCRIPTION

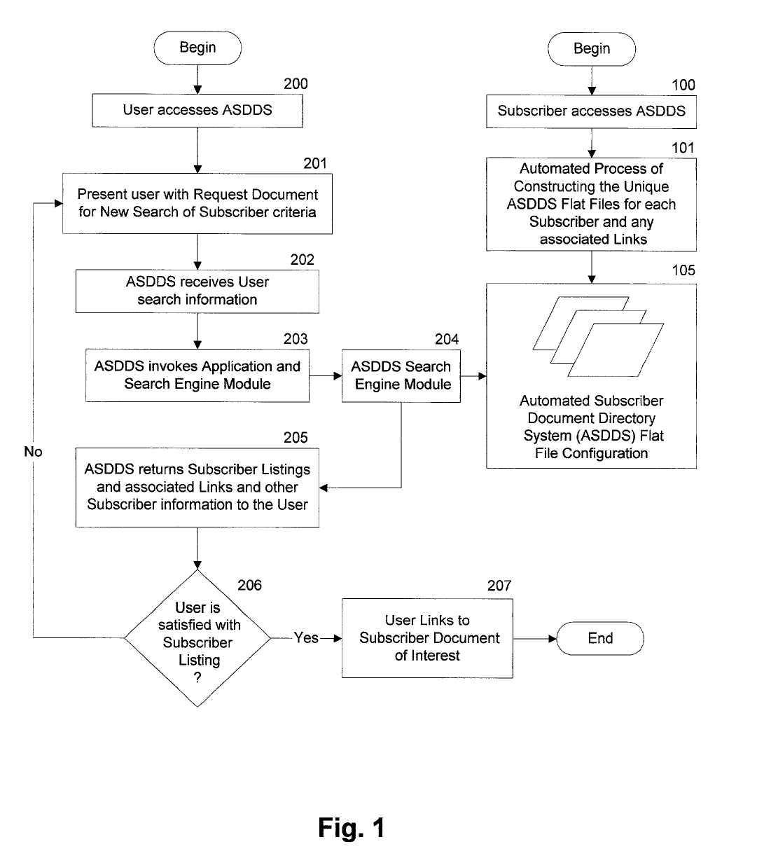

The Automated Subscriber Document Directory System (ASDDS) provides to the User a system for storing, searching, and retrieving a directory listing of subscribed electronic documents and other relevant information. The User enters the ASDDS via the ASDDS electronic request document. FIG. 1 shows the overall process flow of the ASDDS. Each component of the ASDDS is shown in detail in subsequent drawings.

Any User of the ASDDS would complete the ASDDS Request Document (ASDDS-RD) with search criteria and submit the data back to the ASDDS. The ASDDS would then take the data stream, parse and manipulate it, and then send it to the ASDDS Application and Search Engine Module (ASDDS-SEM).

The key critical components are the ASDDS-SEM coupled with the ASDDS Flat File Configuration (ASDDS-FFC). The ASDDS-FFC is dependent on the file name structure of each flat file in the system. These components manage and distribute back to the User the ASDDS Response Document (ASDDS-RD).

The ASDDS-RD displays the compiled listing of all Subscriber Documents (SD) along with any appropriate associated links. A User is able to choose an associated link of the desired SD from the list. Once the link has been completed, if the User is not satisfied with the ASDDS-RD listing, the User may invoke another ASDDS search process by providing new criteria to the ASDDS.

If the User does not wish to view the actual SD, then more specific subscriber information may be available and retrieved from the ASDDS-FFC. This automated directory system would allow a Subscriber to add, update, or remove information from the ASDDS Flat File Configuration (ASDDS-FFC). Periodically the ASDDS will synchronize the subscriber contents with an updated ASDDS Directory Listing.

While a hierarchical overview of the ASDDS process and functionality was described above in the introduction, the details of each component in the system architecture will show the technical uniqueness of this design.

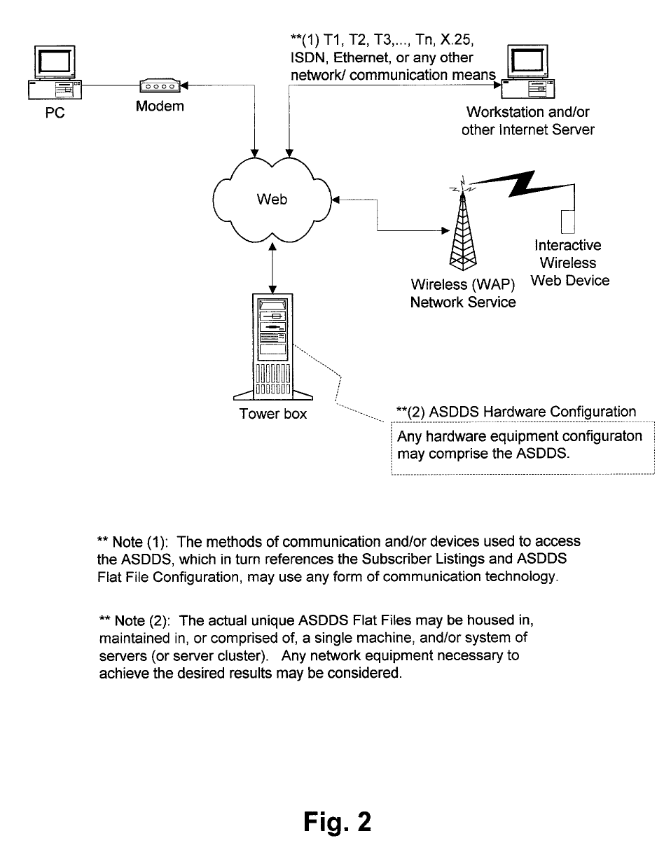

To begin the process the User can use any network/communication means to access the ASDDS (Component: 200). FIG. 2 demonstrates that the method of network/communication is not the issue of the design. Any electronic hardware arrangement may be sought in order to achieve the desired results (see notes ** (1) and ** (2) of FIG. 2.).

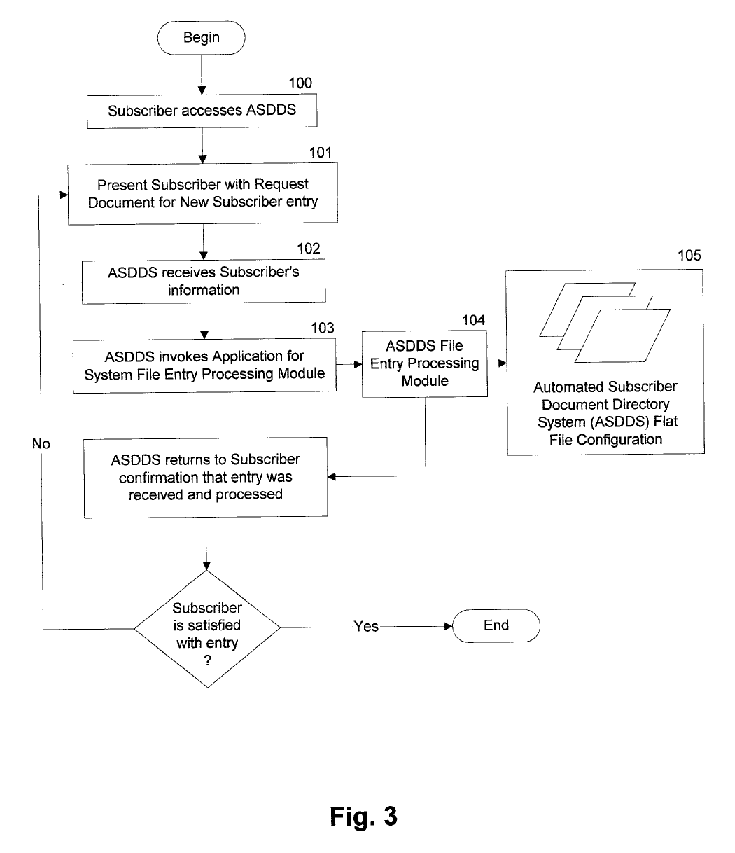

FIG. 3 (Component: 100) begins the automation process for a Subscriber entry and the configuration of the ASDDS unique flat files. Once the Subscriber provides the necessary data and submits the information to the ASDDS, the system invokes the ASDDS Application for System File Entry Processing Module (ASDDS-SFEPM). The ASDDS-SFEPM then integrates with the appropriately named ASDDS flat file to provide the synchronization and updating of the unique files as needed. The ASDDS will respond to the Subscriber with a confirmation that the entry was received and processed successfully. If the Subscriber is satisfied with the entry then this process is terminated. However, if the Subscriber is not satisfied, then there is provided an opportunity to change the information entered into the ASDDS.

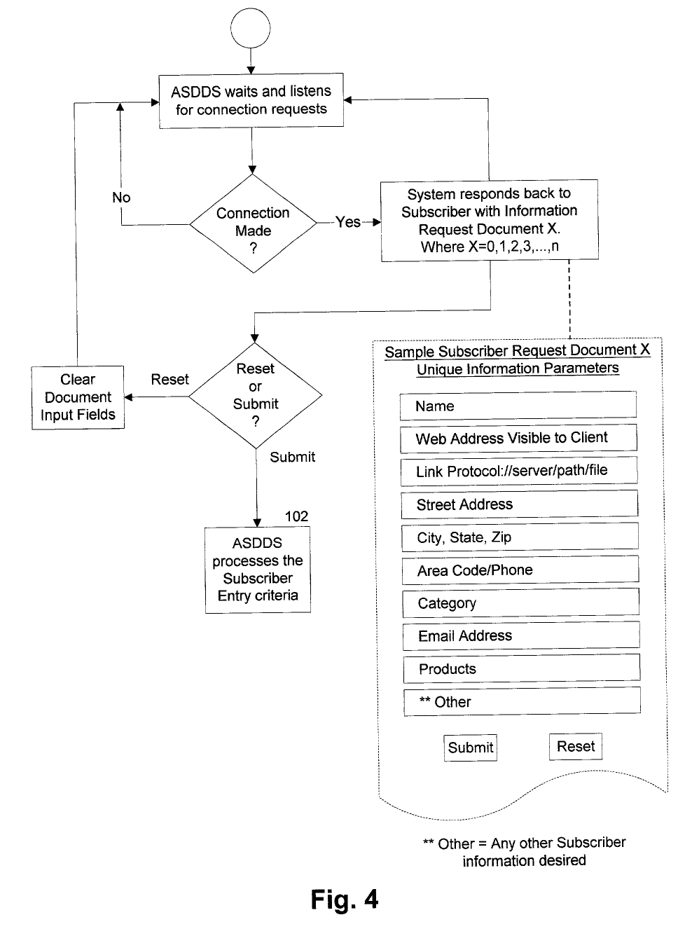

The Automated Process for Listing Subscriber Information on the ASDDS is shown in FIG. 4 (Component: 201). The ASDDS waits and listens for a “Connection” from the Subscriber. When a “Connection” is established, the system responds according to the request(s) on the data stream. The ASDDS then proceeds by invoking the ASDDS-SFEPM.

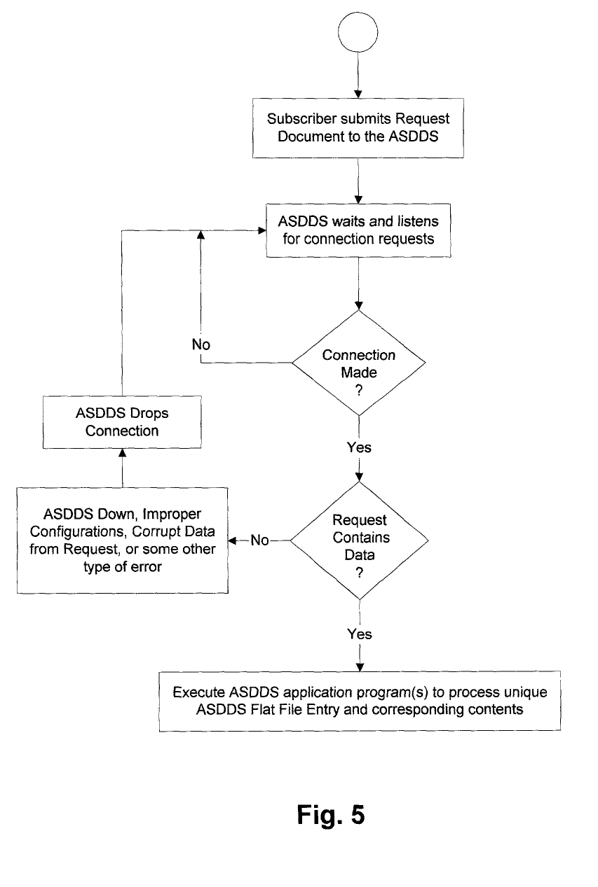

FIG. 5 (Component: 102) shows the automated process of presenting the Subscriber with an electronic request document for new information. The fields of this request document gather information unique to the particular document that the subscriber wants to list. When the Subscriber submits the data to the ASDDS, the ASDDS-SFEPM implements the new entry and corresponding contents, updating the appropriate ASDDS-FFC with a new unique file having a newly defined unique file name.

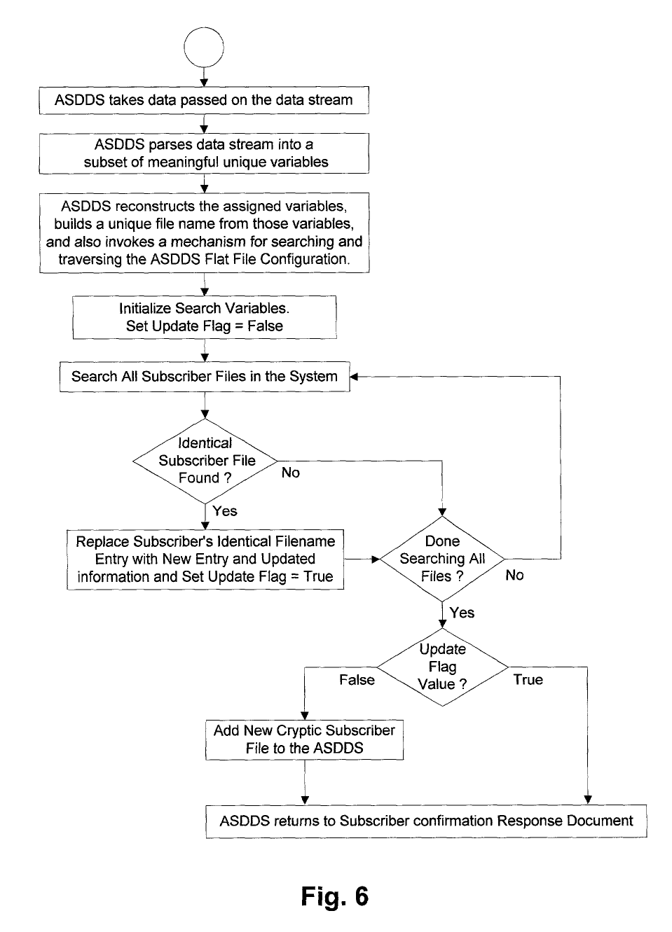

FIG. 6 (Component: 103) demonstrates the ASDDS System File Entry Processing Module (ASDDS-SFEPM). The ASDDS takes the data and parses the data stream into a subset of meaningful unique variables, which are then passed onto the ASDDS-SFEPM. The ASDDS reconstructs the assigned variables and also invokes a mechanism for searching and traversing the ASDDS-FFC. First, the ASDDS searches for any identical entries. If an identical entry is found then the system simply replaces the old entry with the newly created one. However, if an identical entry is not found after traversing all the ASDDS unique flat files in the system, then the ASDDS-SFEPM adds the new entry and updates the ASDDS accordingly. The Subscriber may repeat this process as necessary.

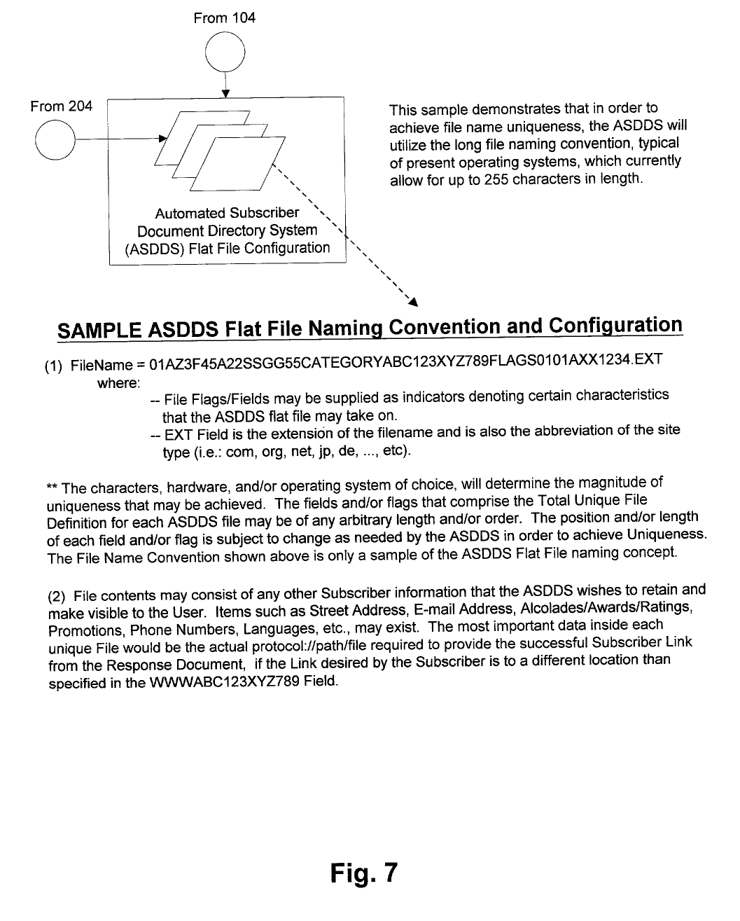

The ASDDS Flat File Configuration (ASDDS-FFC) provides the storage basis for the ASDDS and is comprised of a unique file naming convention and configuration as shown in FIG. 7 (Component: 104). Each file name in the ASDDS consists of fields and/or flags with value, thereby providing the pertinent technical intelligence required for the system to operate. Each value provides a reference that integrates with the ASDDS Search Engine Module (ASDDS-SEM.) Refer to Note (1) on FIG. 7 for more detail.

The contents of each flat file in the ASDDS will retain any additional information the User and/or Subscriber wish to examine or include respectively. Refer to Note (2) on FIG. 7 for more detail. Furthermore, it should be noted that FIG. 7 only demonstrates an example of what the file name might consist of. The position and/or length of each field and/or flag in the file name are subject to change as needed by the ASDDS-SEM.

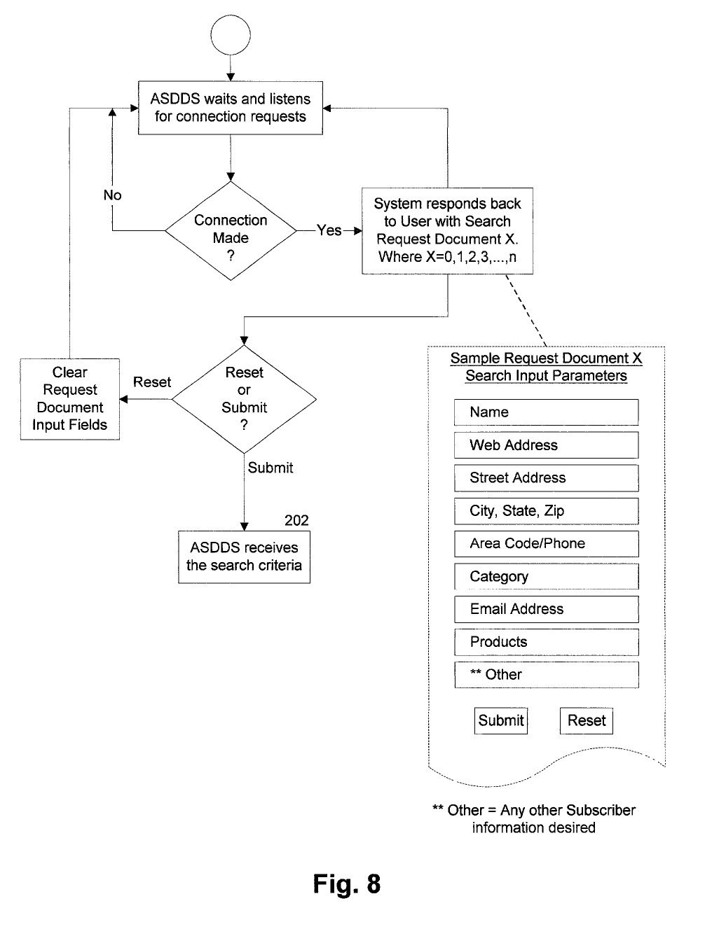

FIG. 8 (Component: 201) represents the process of presenting the User with the ASDDS Request Document. The ASDDS actively waits and listens for incoming “Connection” requests. When a “Connection” is accepted, the system responds back to the User with the Request Document. The Request Document would be made up of different data components and search parameters required for the ASDDS-SEM. Many search input fields may be used in order to reduce the “strain” on the ASDDS-SEM and thereby providing a faster, shorter, and more desirable directory listing to the User. If unsatisfied, the User may increase or decrease the scope of the search.

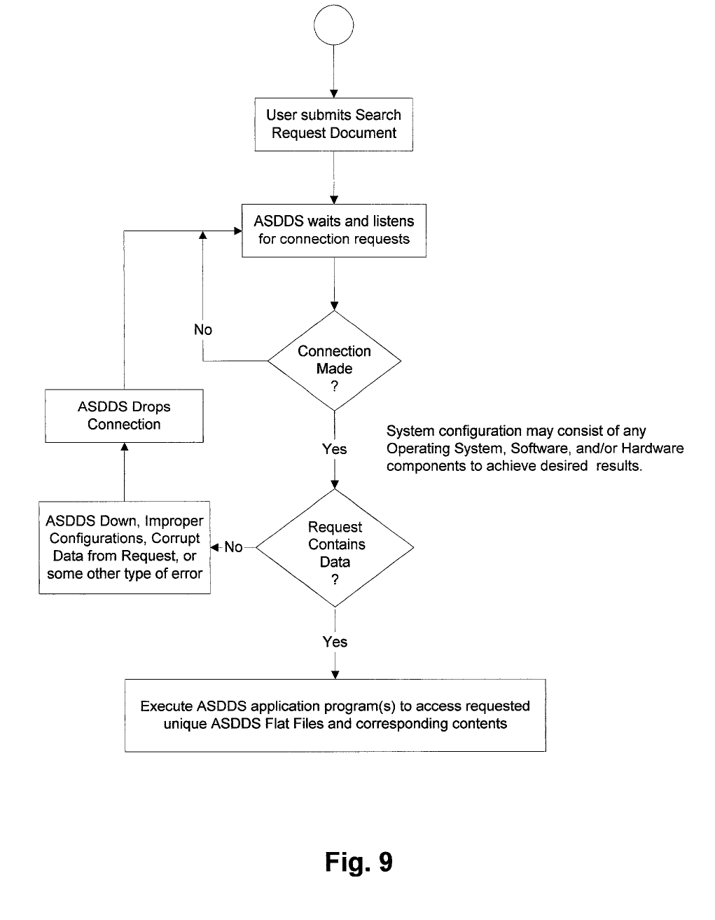

The User inputs the ASDDS search criteria and submits the information to the ASDDS as shown in FIG. 9 (Component: 202). Once a “Connection” is established, the system responds accordingly to the request(s) on the data stream. The ASDDS then proceeds by executing the ASDDS application programs, which access the appropriate ASDDS Flat File (ASDDS-FF). These ASDDS programs make up the ASDDS-SEM. In order to search the ASDDS and find the appropriate contents of the Automated Subscriber Document Directory for the User, the ASDDS must make use of the parameters and/or input values from the Request Document.

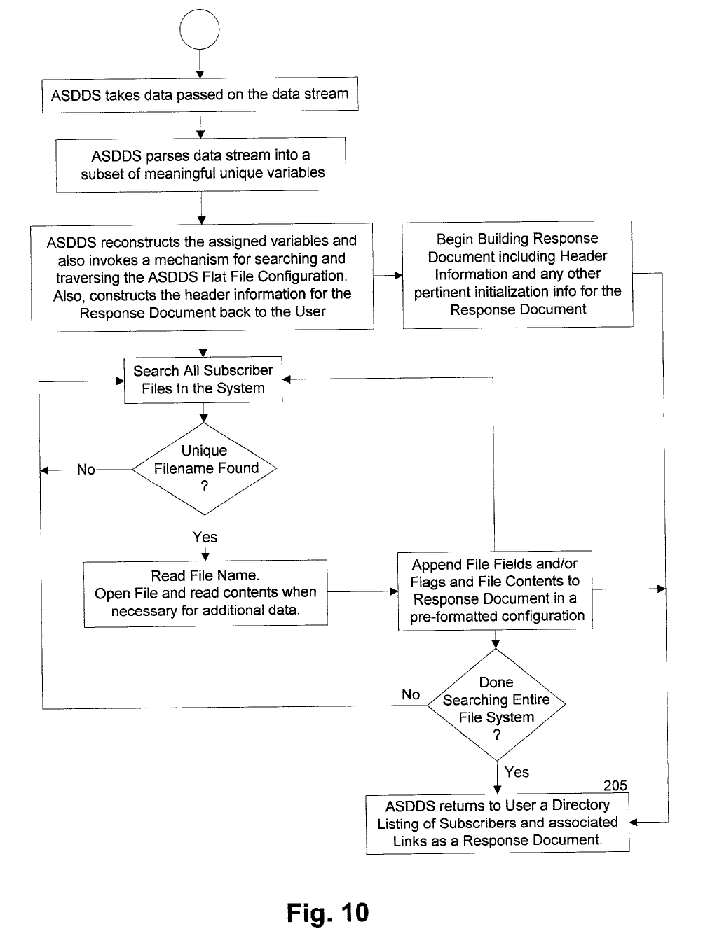

The search mechanism itself is the heart of the ASDDS-SEM and is represented in FIG. 10 (Component 203). The mechanism will search each file in the ASDDS looking for unique file names that match the criteria given by the User. This process continues until all files have been traversed. For each file that matches the criteria, the application program(s) begin to retrieve and assemble a response from matched “File Fields” and/or “File Flags” from the associated file name. As the list of matched files is compiled, the ASDDS is concurrently synchronizing and updating a directory listing that will be sent back to the User for viewing.

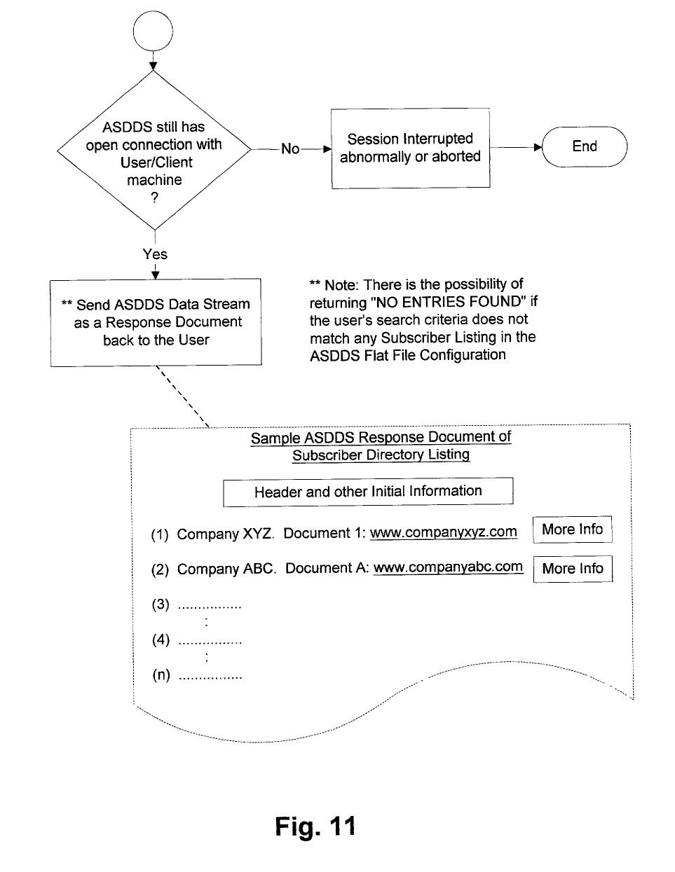

FIG. 11 (Component: 205) shows the ASDDS-RD as it returns a directory listing with associated links. There is the possibility that two error conditions could occur as well. The first is that the request session may have ended abnormally or aborted. The second is that the ASDDS may have not found any entries that match the User's search criteria. This condition is not really an error of the ASDDS, but rather a mismatch of the criteria entered by the User.

In the Sample ASDDS-RD, there is also the capability for the User to request “more information.” When this condition occurs, the ASDDS-SEM will need to not only read the file name that matches the directory listing, but will also, at times, need to open and read the file contents for any additional data. The ASDDS-RD would return the results of the “more information” request. These additional items would be the same as denoted in FIG. 8 on the ASDDS Request Document. The additional information is also referenced in FIG. 7, note (2). Once all files have been traversed and interrogated, the ASDDS-RD is sent back to the User.

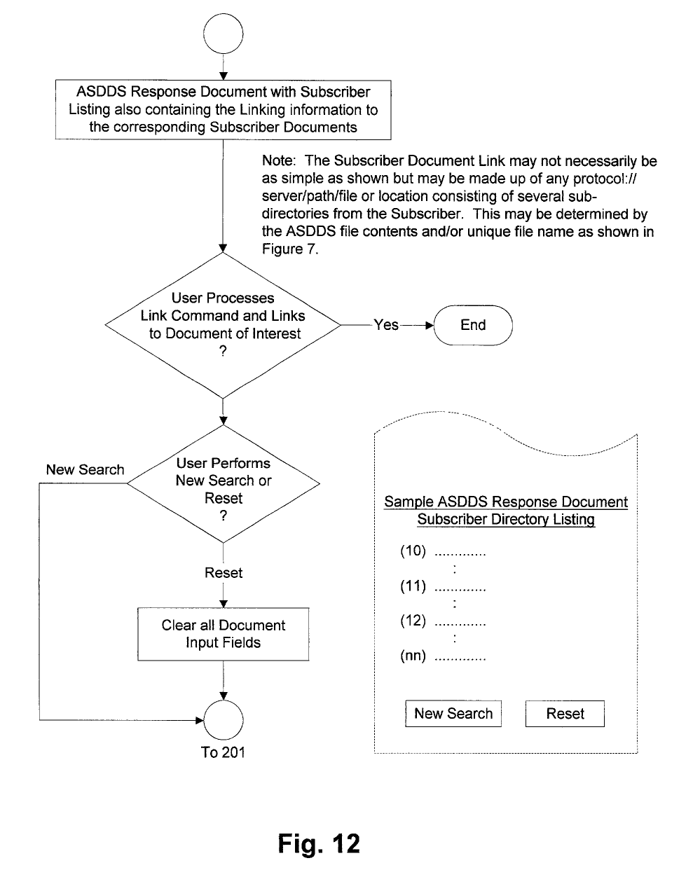

FIG. 12 (Components: 206 and 207) is simple a continuation of FIG. 11. However, FIG. 12 also deals with the linking process as well as giving the User the ability to perform a new search. If the User decides to perform a new search, the process begins once again starting from FIG. 8 (Component: 201), otherwise the process is completed.

What is claimed is:

1. A Directory Listing System which is based on flat files and a cryptic file naming configuration comprising the following:
An automated application for System File Entry processing where a Subscriber lists documents by entering information into an electronic request document which creates a cryptic file name, a flat file and a link to the listed document.
A cryptic file name that is configured with characters with defined values as placeholders for defined fields and flags (and the flat file itself may contain more information about the listing.)
An automated search application where a User may define search criteria via an electronic Search Request Document; and the Search Engine Module then interprets variables that correspond to flat file naming configuration, interrogates for matched fields and/or flags, and finally compiles and returns to the User a listing of files.

2. The method of claim 1 consisting of an Automated Application for System File Entry Processing in which a Subscriber lists documents by entering pertinent information into request fields of an electronic response document. Then after the requested information is manipulated a listing is automatically generated flags, a unique flat file with relevant information, and a link back to the listed document.

3. The method of claim 1 consisting of a File Naming Convention and Configuration where the name of the flat file is configured with characters (which may be encrypted) with defined values. Each of the characters of the file name including the extension is a placeholder for symbolic fields and flags that have definition. These fields and flags are adjustable and enable nimble searches using just the files' names.

4. The method of claim 1 consisting of an Automated Search Application where a User may define categories of inquiry via an electronic Search Request Document, and the Search Engine Module then interprets the criteria's relevance to variables corresponding to the flat file naming configuration, interrogates for matched fields and/or flags, and finally compiles and returns a listing of existing matched files to the User. providing the pertinent technical intelligence required for the system to operate. Each value provides a reference that integrates with the ASDDS Search Engine Module. The search and retrieval methodology involved would include an interactive request form, which the User would use to define a listing. Such definition may be as specific, or as broad as the searcher wishes. Upon receiving these criteria, the system will perform a file and directory search process, interrogating the unique flat file naming configuration. The system will find the desired information and supply the User with a listing of relevant electronic documents and information and their corresponding links. The User is then able to view and traverse this listing in order to find the desired specific information. If necessary the User may further refine the search criteria. Once the desired information has been found, the User would have the ability to link to the associated electronic documents.
